(19) United States
(12) Patent Application Publication
(10) Pub. No.: US 2010/0313168 A1
(43) Pub. Date: Dec. 9, 2010

(54) PERFORMING CHARACTER SELECTION AND ENTRY

(75) Inventors: Peter Wiest, Sammamish, WA (US); Andrew James Jaffray, Seattle, WA (US); Craig Taylor, Monroe, WA (US); Alexander Appa, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/479,491

(22) Filed: Jun. 5, 2009

(51) Int. Cl. G06F 3/048

(52) U.S. Cl. 715/830; 715/834; 715/810

(57) ABSTRACT

Methods and systems for performing character selection and entry are provided herein. One exemplary method includes displaying a character group menu on a display, the character group menu including a plurality of character groups arranged about a central region of the character group menu, each of the plurality of character groups having a plurality of characters. The method further includes selecting, from the character group menu, a selected character group in response to a group selection operation applied to a directional controller. The method further includes displaying a character menu on the display responsive to the selecting of the selected character group, the character menu including the plurality of characters of the selected character group arranged about a central region of the character menu. The method further includes selecting, from the character menu, a selected character in response to a character selection operation applied to the directional controller.

### BACKGROUND

Digital text entry onto a computing system often involves the use of a keyboard or pointing device, such as a mouse cursor. Digital text entry may be challenging when a keyboard and/or mouse is unavailable, as can be the case when entering digital text using gaming controllers. To increase efficiency and accuracy of digital text entry, attempts have been made to design user interfaces that offer the user an intuitive and efficient mechanism for entering text without a keyboard.

### SUMMARY

Methods and systems for performing character selection and entry are provided herein. One exemplary method includes displaying a character group menu on a display, the character group menu including a plurality of character groups arranged about a central region of the character group menu. The method further includes selecting a selected character group in response to a group selection operation applied to a directional controller. A character menu is displayed responsive to the selecting of the selected character group, where the character menu includes the characters of the selected character group arranged about a central region of the character menu. The method further includes selecting a selected character from the character menu in response to a character selection operation applied to the directional controller.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a time series of character selection and entry events.

FIG. 2 is a schematic view of an exemplary computing system for performing character selection and entry.

FIG. 3 is a flowchart illustrating an exemplary method for performing character selection and entry.

FIG. 4 is a schematic view of a time series of character selection and entry events in a second embodiment.

### DETAILED DESCRIPTION

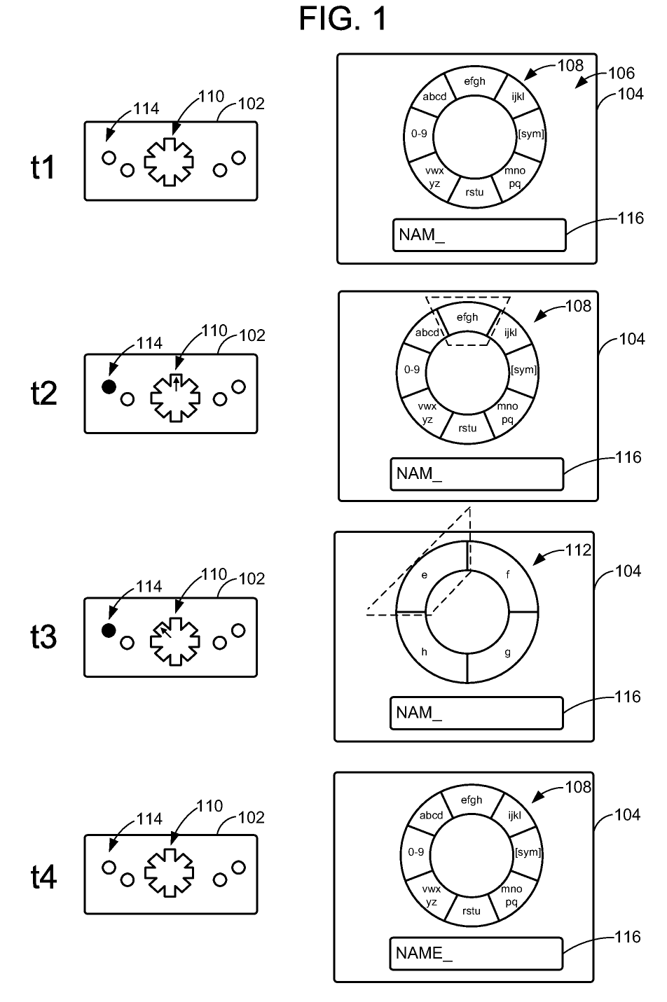

FIG. 1 is a schematic view illustrating a time series of character selection and entry events performed in connection with a character entry interface 106 which may be presented on a display 104. As shown at time t1, character entry interface 106 may display a character group menu such as character group menu 108 having character groups for selection via operation of a directional controller 102. Character entry interface 106 may also include a character menu 112, as shown at time t3, having characters for selection via operation of directional controller 102. Specifically, directional inputs may be applied to a direction actuator 110 and actuation inputs may be applied to a button actuator 114 of the directional controller 102. In the context of a character group menu, the direction actuator can be used to highlight a particular character group for selection, with the selection operation being performed via operation of button actuator 114.

FIG. 1 is an illustration of character selection and entry events which are described in the example context of entering the character string “NAME” in character entry box 116 of character entry interface 106. At time t1, the display 104 shows character group menu 108 displaying eight selectable character groups (e.g., “abcd”, “efgh”, etc.). At time t2, an upward directional input at direction actuator 110 causes highlighting of character group “efgh”, and the depicted operation of button actuator 114 causes a selection of the “efgh” character group. Thus, at time t3, a plurality of characters (e.g., “e”, “f”, “g”, and “h”) of the selected character group are displayed via presentation of character menu 112. In this example, an upward-left directional input is applied to direction actuator 110, which in turn highlights a particular one of the characters on the character menu. Specifically, the upward-left direction of the input causes highlighting of character “e” or a highlighting or other emphasis of the region in which “e” is displayed. Then, as with the character group menu, operation of button actuator 114 causes the selection of character “e”. As shown at time t4, the selected character is then displayed at an end of a string of characters in character entry text box 116. Furthermore, the display 104 may then display the character group menu 108 for a subsequent series of character selection and entry events.

Various alternatives exist for performing the group selection operation and the character selection operation. In one example, when a selected character group is highlighted (e.g., the “efgh” character group), a button such as button actuator 114 is depressed to cause the character group to be selected and the corresponding character menu to be displayed. Then, the character selection operation (e.g., selection of the character “e”) is performed by releasing the already-depressed button actuator. In another example, a highlighted character group or character is selected after a timeout period. In particular, the interface may infer, as a result of a user leaving a group/character highlighted for a specified period of time, that the user intended or wanted to select the highlighted character/group.

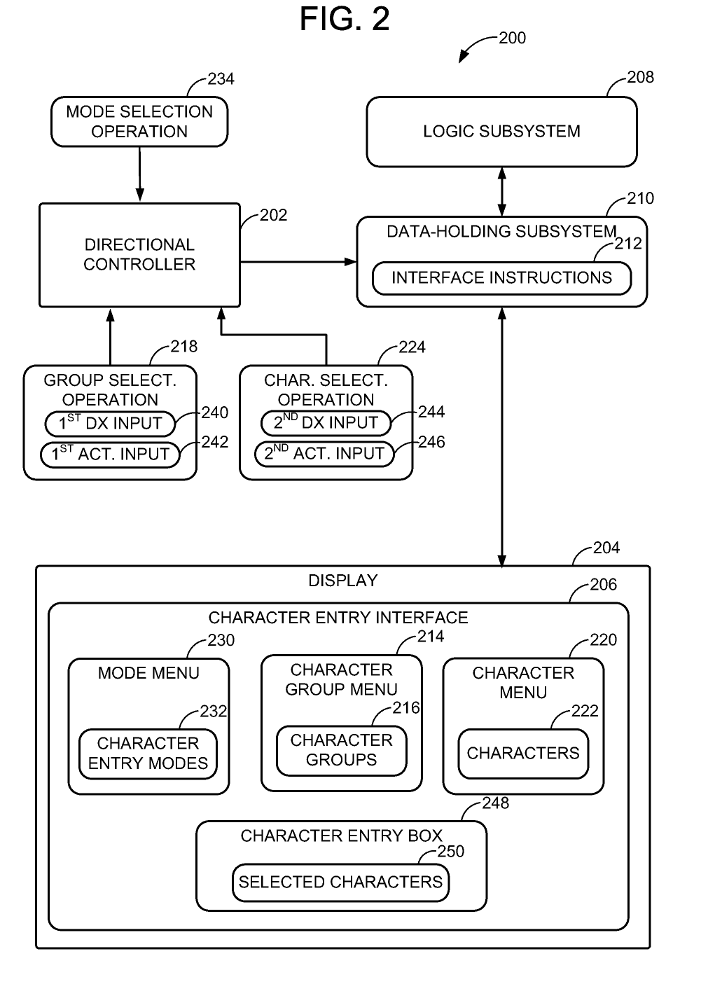

Turning now to FIG. 2, the figure depicts an exemplary computing system 200 for performing character selection and entry, such as that illustrated by the events of FIG. 1. The computing system 200 includes a directional controller 202 and a display 204 operatively coupled to the directional controller 202. Display 204 can display a character entry interface 206 which is navigable via operation of the directional controller 202. FIG. 1 depicts a particular exemplary configuration for character entry interface 206, including a ring of radially-disposed selectable options, although other configurations may be employed.

Computing system 200 may include a logic subsystem 208 and a data-holding subsystem 210 including interface instructions 212 executable by the logic subsystem 208 to permit user selection and entry of characters. The data-holding subsystem 210 may be a computer-readable storage medium, such as a hard drive integrated in the computing system, a portable hard drive, a compact disc, a DVD, etc. Such a computer-readable storage medium may be used to store and/or transfer data or instructions executable by a logic subsystem to implement the methods and processes described herein.

The interface instructions 212 may be executable by the logic subsystem 208 to display a mode menu 230 on the display 204, where the mode menu 230 includes a plurality of character entry modes 232. Each character entry mode may include a character group set. As an example, some languages have many characters, and all of the characters may not be displayable on one character group menu. Thus, several character entry modes can be provided, each character entry mode having a character group set. Thus, a first character entry mode may include, for example, the Japanese Hiragana symbol set, and a second character entry mode may include the Japanese Katakana symbol set. The interface instructions 212 may be further executable to select, from the plurality of character entry modes 232, a selected character entry mode responsive to a mode selection operation 234 applied to the directional controller 202. In this way, the computing system 200 can provide international support for users of the computing system 200.

Other character entry modes 232 may include a lowercase mode for selection and entry of lowercase letters, an uppercase mode for selection and entry of uppercase letters, a numeric mode for numeral selection and entry, and various symbol modes for selection and entry of various symbol types. FIG. 1 illustrates an example of a mode allowing for entry of lowercase letters with selectable groups for entry of some numerals and symbols.

In some examples, responsive to the selection of a character entry mode, the interface instructions 212 may be executable by the logic subsystem 208 to display a character group menu 214 of the character entry interface 206 on the display 204, such as the character group menu 108 shown at times t1, t2, and t4 of FIG. 1. A character group menu may include a plurality of character groups 216 (e.g., the character groups “abcd”, “efgh”, etc. of FIG. 1) arranged about a central region of the character group menu 214. Each of the plurality of character groups 216 is selectable and has, or is associated with, a plurality of characters.

Accordingly, the interface instructions 212 may be further executable by the logic subsystem 208 to select, from the plurality of character groups 216, a selected character group responsive to a group selection operation 218 applied to the directional controller 202. An example of such a group selection operation is illustrated at time t2 of FIG. 1. The particular character input that is chosen for selection (e.g., highlighted) may be dependent upon a direction of the group selection operation 218. That is, the group selection operation may include a first directional input 240 applied to the directional controller (e.g., pointing of a joystick), as well as a first actuation input 242 (e.g., pushing of a button actuator).

One example, shown in FIG. 1, illustrates the directional controller 102 as implemented with a direction actuator in the form of a directional pad, or D-pad, having eight possible directional inputs. Thus, the first directional input 240 may be an actuation of such a D-pad in any of its available directions.

In addition to or instead of a D-pad, directional controller 202 may include a joystick or any other suitable two-axis directional controller. Thus, the first directional input 240 could be a movement of a joystick in any of a variety of directions to highlight a particular character group for selection. A joystick or other suitable two-axis direction actuator allows a user to “point” to a desired character group. Accordingly, the joystick may be desirable in certain settings over a D-pad, as it provides the ability to point in an effectively limitless number of directions. A D-pad, in contrast, may be much more granular and discrete in terms of its directional capability (e.g., a D-pad may only allow pointing in four, two or some other limited number of directions).

Continuing with FIG. 2, when the first directional input 240 is applied to the directional controller 202, the selected character group may be highlighted or otherwise selected or emphasized on the display 204, for example, by presenting it in a different color. In this way, the user may receive visual, real-time feedback prior to applying a first actuation input 242 (e.g., pressing of button actuator) to the directional controller 202 to select the particular character group. As an example, at time t2 of FIG. 1, a first directional input is applied via direction actuator 110 to highlight the “efgh” character group prior to application of the first actuation input (e.g. pressing of button actuator 114) to select the “efgh” group as the selected character group.

Responsive to selection of the selected character group, the interface instructions 212 may be executable to display a character menu 220 of the character entry interface 206 on the display 204. In some examples, such as shown at time t3 of FIG. 1, the selection of a character group causes the character group menu to disappear and be replaced with a character menu.

The character menu 220 may include the plurality of characters 222 from the selected character group, arranged about a central region of the character menu 220. For example, at time t3 of FIG. 1, character menu 112 includes characters “e”, “f”, “g”, and “h” radially arranged around the central region of the character menu 112.

Accordingly, the interface instructions 212 may be executable by the logic subsystem 208 to select, from the character menu 220, a selected character responsive to a character selection operation 224 applied to the directional controller 202. The selecting of the selected character may be dependent upon a direction of the character selection operation. Thus, the character selection operation 224 can include a second directional input 244 (e.g., the actuation of the “up-left” button at time t3 in FIG. 1) and a second actuation input 246 (e.g., actuation of the button actuator at time t3 in FIG. 1) applied to the directional controller 202.

When the second directional input 244 is applied to the directional controller 202, the selected character may be highlighted on the display 204, for example, in a different color. In this way, the user may receive visual, real-time feedback prior to applying a second actuation input 246 (e.g., actuation of a button actuator) to the directional controller 202 to select the character to be the selected character. As an example, at time t3 of FIG. 1, the second directional input (e.g., actuation of an “up-left” button of direction actuator 110) is first applied to the directional controller 102, and the “e” character group is highlighted. Then, the second actuation input (e.g., actuation of button actuator 114) is applied to the directional controller 102 to select the “e” character.

Upon selection of a selected character, the logic subsystem 208 may execute interface instructions 212 to display the selected character in a character entry box 248 of the display 204. For example, as shown at time t4 of FIG. 1, character “e” can be added to the end of a string of selected characters 250 to display the string “Name”.

It may be appreciated that although the plurality of character groups are displayed in FIG. 1 as radially arranged about the central region of the character group menu 108 such that the character group menu 108 appears as a wheel, or ring, any suitable arrangement of character groups about a central region of a character group menu can be implemented. Character menus, such as character menu 112, may similarly be implemented in various alternate configurations.

Using a computing system such as that described with respect to FIG. 2 for character selection and entry can allow a high character entry rate by reducing the number of selection operations to select any character. In the examples described with respect to FIG. 1 and FIG. 2, the number of selection operations to select any of the characters is two selection operations. In other examples, the number of selection operations to select any character may be less than two and/or more than two selection operations. Furthermore, the visibility of selectable characters throughout the selection process provides an intuitive interface such that a user can quickly understand how to navigate and/or use the character entry interface for character selection and entry. In some examples, graphical cues may be displayed on a display, to assist a user in understanding how to select a particular character group from a character group menu or a particular character from a character menu.

It may be appreciated that other input controls may be used along with the directional input and actuation inputs described above. For example, actuation of additional button actuators of a D-pad or joystick, or gestures of the D-pad or joystick, may cause a backspace, or erasure, of a selected character. In other examples, actuation of additional button actuators or gestures may cause a change in capitalization mode (e.g., lower case entry to upper case entry), a change in character set (e.g., a change in character entry mode, such as a switch from a first Japanese character set to a second Japanese character set), and/or a selection of pre-defined characters (e.g., space character) or character sequences (e.g., common phrases or common letter pairings).

Furthermore, with respect to FIG. 2, computing system 200 may optionally include a display subsystem and/or other components not shown in FIG. 2. When included, display subsystem may be used to present a visual representation of data held by data-holding subsystem 210. As the herein described methods and processes change the data held by the data-holding subsystem, and thus transform the state of the data-holding subsystem, the state of a display subsystem may likewise be transformed to visually represent changes in the underlying data. A display subsystem may include one or more display devices utilizing virtually any type of technology. Such display devices may be combined with logic subsystem 208 and/or data-holding subsystem 210 in a shared enclosure, or such display devices may be peripheral display devices.

Logic subsystem 208 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem 208 may optionally include individual components that are distributed throughout two or more devices, which may be remotely located in some embodiments.

Data-holding subsystem 210 may include one or more physical devices configured to hold data and/or instructions executable by the logic subsystem to implement the herein described methods and processes. When such methods and processes are implemented, the state of data-holding subsystem 210 may be transformed (e.g., to hold different data). Data-holding subsystem 210 may include removable media and/or built-in devices. Data-holding subsystem 210 may include optical memory devices, semiconductor memory devices, and/or magnetic memory devices, among others. Data-holding subsystem 210 may include devices with one or more of the following characteristics: volatile, nonvolatile, dynamic, static, read/write, read-only, random access, sequential access, location addressable, file addressable, and content addressable. In some embodiments, logic subsystem 208 and data-holding subsystem 210 may be integrated into one or more common devices, such as an application specific integrated circuit or a system on a chip.

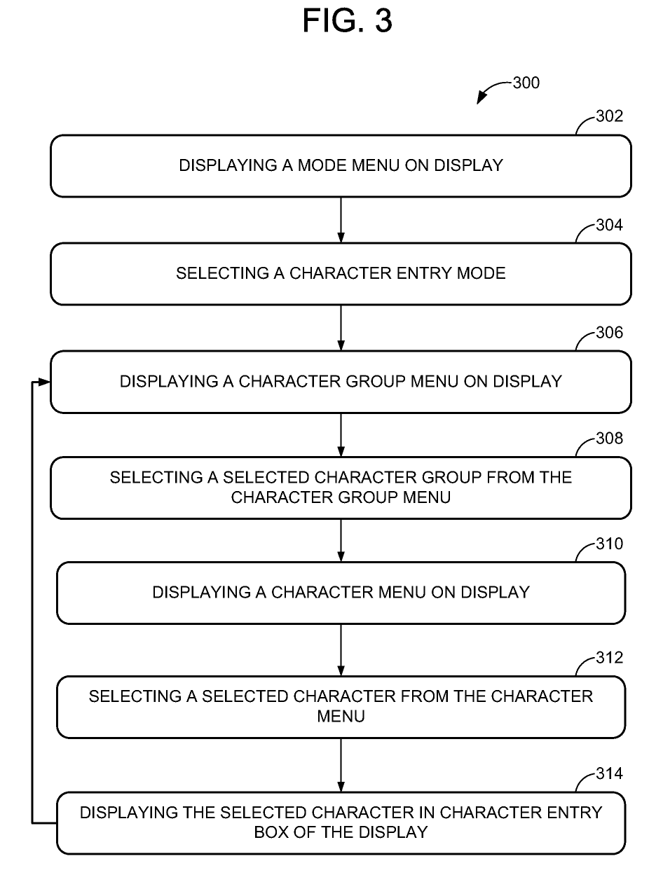

Turning now to FIG. 3, a flowchart illustrates an exemplary method 300 for performing character selection and entry. At 302, the method 300 includes displaying a mode menu including a plurality of character entry modes on a display. Each character entry mode may include a character group set as discussed above.

Thus, the method 300 may include selecting, from the plurality of character entry modes, a selected character entry mode responsive to a mode selection operation applied to a directional controller, as shown at 304. Responsive to selection of a selected character entry mode, the method 300 may include displaying a character group menu on a display at 306. As discussed with respect to FIG. 2, the character group menu may include a plurality of selectable character groups arranged about a central region of the character group menu, with each of the character groups including multiple characters.

At 308, the method 300 may include selecting a selected character group from the plurality of character groups of the character group menu in response to a group selection operation applied to a directional controller. The group selection operation may include a first directional input, such the previously described pointing operations performed with a D-pad, joystick or other direction actuator.

At 310, the method 300 may include displaying a character menu on the display responsive to the selecting of the selected character group. As discussed above, the character menu may include the plurality of characters of the selected character group arranged about a central region of the character menu, and in some cases the character menu may be presented so as to replace the character group menu on the display.

Thus, at 312, the method 300 may include selecting a selected character from the character menu in response to a character selection operation applied to the directional controller. The character selection operation may include a second directional input applied to a direction actuator as described above. Then, a second actuation input (e.g., button actuation of a D-pad or joystick) is applied to the directional controller to thereby select the highlighted character. As shown at 314, the method may include displaying the selected character in a character entry box of the display. Furthermore, the various steps may be performed repeatedly in order to enter a multiple-character sequence or string of characters.

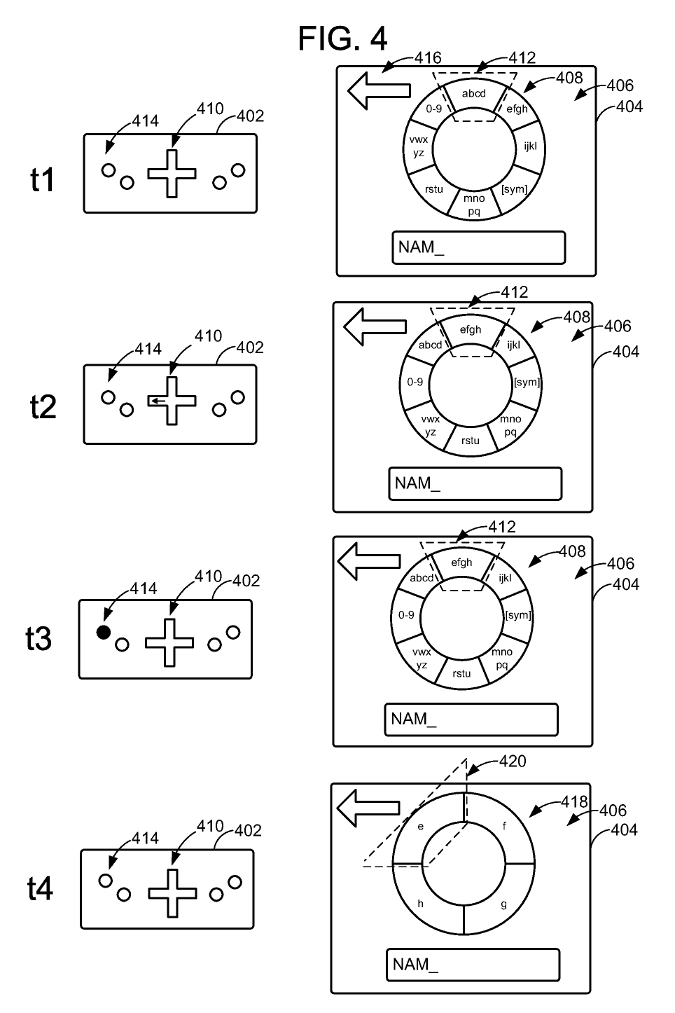

Turning now to FIG. 4, the figure depicts an alternative implementation for an interactive character entry interface. The alternative implementation is described in similar fashion to FIG. 1 in a time sequence t1, t2, etc. showing various interactions between a directional controller 402 and the character entry interface. In this example, directional controller 402 includes a direction actuator 410 in the form of a 4-direction D-pad. Although inputs in any of four directions may be applied using actuator 410, the interface may be constructed so as to be navigable by an even simpler controller, such as a one-axis D-pad, as will be explained.

Continuing with the figure, display 404 is displaying a character group menu 408 of character entry interface 406. In this example, the character group menu 408 has a selectable region 412 indicated by the dashed lines. Inputs applied to direction actuator 410 may be used to vary the positioning of selectable items in a given menu, so that a desired item is positioned within the selectable region, thereby allowing selection to then occur, for example upon activation of a button actuator. More particularly, in the present example, the menus are presented as in some of the prior examples as rings or wheels with selectable items radially arranged about a central region. Directional inputs may then be applied to directional controller 402 to rotate the menu to position a desired item within the selectable region.

For example, at time t1, character group menu 408 is shown with character group “abcd” in the selectable region 412. A graphical cue 416 on display 404 may be used to indicate to a user that a leftward directional input at the direction actuator 410 may rotate the character groups left-ward, or counterclockwise about the central region of the character menu 418.

Accordingly, a leftward input at the direction actuator 410 may be received at t2 (indicated by the left-ward arrow on direction actuator 410) and the character groups may then rotate about the central region of character group menu 408. As a result of the rotation, the character groups are repositioned so that character group “efgh” in the selectable region 412. In this way, in contrast to the previous examples, the character groups move on the display while selectable region 412 is stationary.

Thus, the method 300 described with respect to FIG. 3 may include rotating a plurality of character groups about a central region of a character group menu from a first character group menu position to a second character group menu position responsive to a first directional input, to thereby position a new one of the plurality of the character groups in the selectable region of the character group menu. Such rotation may occur, for example, responsive to actuation of a direction actuator (e.g., left, right, up, down, etc.), and subsequent similar actuations of a same direction actuator may cause a second rotation, so that a second new one of the plurality of the character groups is in the selectable region. In this way, the selectable region may not move while the character groups do move.

At time t3 on FIG. 4, desired character group “efgh” is in the selectable region 412, and actuation of button actuator 414 may result in selection of the character group “efgh” in the selectable region 412.

Accordingly, at t4, character menu 418 may be displayed in the character entry interface 406, with character “e” in a selectable region 420. An actuation of direction actuator 410 may cause rotation of the character menu about a central region of the character menu, in a similar manner as that of the character group menu 408, and actuation of button actuator 414 may cause selection of a character in the selectable region 420.

Thus, it can be understood that the method 300 as described with respect to FIG. 3 may further include rotating the plurality of characters about the central region of the character menu from a first character menu position to a second character menu position responsive to a directional input to thereby position a new one of the plurality of the characters in a selectable region of the character menu. Also, selection of a selected character may occur by actuation of a button actuator, such as button actuator 414 of FIG. 4 when the desired character for selection is in a selectable region of a character menu.

The described repositioning of character groups relative to a stationary selectable region may be desirable in settings where a single-axis direction actuator is used for input. Alternatively, such a single-axis direction actuator could be used to move a selectable region to a desired character group or character. For example, the selectable regions shown in FIG. 4 could move around the depicted wheel menus in response to operation of a one-axis D-pad or other single-axis direction actuator.

In some embodiments, the above described methods and processes may be tied to a computing device or system, such as computing system 200 described in FIG. 2. Furthermore, it will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for performing character selection and entry, the method comprising:
displaying a character group menu on a display, the character group menu including a plurality of character groups arranged about a central region of the character group menu, each of the plurality of character groups being selectable and having a plurality of characters;
selecting, from the plurality of character groups of the character group menu, a selected character group in response to a group selection operation applied to a directional controller;
displaying a character menu on the display responsive to the selecting of the selected character group, the character menu including the plurality of characters of the selected character group arranged about a central region of the character menu; and
selecting, from the character menu, a selected character in response to a character selection operation applied to the directional controller.

2. The method of claim 1, where displaying the character menu includes replacing, on the display, the character group menu with the character menu.

3. The method of claim 1, where the plurality of character groups are radially arranged about the central region of the character group menu, and where the plurality of characters are radially arranged about the central region of the character menu.

4. The method of claim 1, where the group selection operation applied to the directional controller includes a first directional input and a first actuation input applied to the directional controller, and where the character selection operation applied to the directional controller includes a second directional input and a second actuation input applied to the directional controller.

5. The method of claim 4, further comprising rotating the plurality of character groups about the central region of the character group menu from a first character group menu position to a second character group menu position responsive to the first directional input to thereby position a new one of the plurality of the character groups in a selectable region of the character group menu, and further comprising rotating the plurality of characters about the central region of the character menu from a first character menu position to a second character menu position responsive to the second directional input to thereby position a new one of the plurality of the characters in a selectable region of the character menu.

6. The method of claim 1, where the selecting of the selected character group occurs responsive to a group selection operation applied to a joystick and the selecting of the selected character occurs responsive to a character selection operation applied to the joystick.

7. The method of claim 1, where the selecting of the selected character group occurs responsive to a group selection operation applied to a D-pad and the selecting of the selected character occurs responsive to a character selection operation applied to the D-pad.

8. The method of claim 1, further comprising:
displaying a mode menu including a plurality of character entry modes, each character entry mode including a character group set; and
selecting, from the plurality of character entry modes, a selected character entry mode responsive to a mode selection operation applied to the directional controller.

9. The method of claim 8, where displaying the character group menu includes displaying the character group menu responsive to the selecting of the selected character entry mode.

10. The method of claim 1, further comprising displaying the selected character in a character entry box on the display.

11. A computing system for performing character selection and entry, the computing system comprising:
a directional controller;
a display operatively coupled to the directional controller and configured to display a character entry interface which is navigable via operation of the directional controller to permit user selection and entry of characters;
a logic subsystem; and
a data-holding subsystem including interface instructions executable by the logic subsystem to:
display a character group menu of the character entry interface on the display, the character group menu including a plurality of character groups arranged about a central region of the character group menu, each of the plurality of character groups being selectable and having a plurality of characters,
select, from the plurality of character groups of the character group menu, a selected character group responsive to a group selection operation applied to the directional controller,
display a character menu of the character entry interface on the display responsive to selection of the selected character group, the character menu including the plurality of characters of the selected character group arranged about a central region of the character menu, and
select, from the character menu, a selected character responsive to a character selection operation applied to the directional controller.

12. The computing system of claim 11, where the interface instructions are executable to display the character menu by replacing, on the display, the character group menu with the character menu.

13. The computing system of claim 11, where the plurality of character groups are radially arranged about the central region of the character group menu, and where the plurality of characters are radially arranged about the central region of the character menu.

14. The computing system of claim 11, where the group selection operation applied to the directional controller includes a first directional input and a first actuation input applied to the directional controller, and where the character selection operation applied to the directional controller includes a second directional input and a second actuation input applied to the directional controller.

15. The computing system of claim 11, where the interface instructions are executable by the logic subsystem to select the selected character group responsive to a group selection operation applied to a joystick, and where the interface instructions are executable by the logic subsystem to select the selected character responsive to a character selection operation applied to the joystick.

16. The computing system of 11, where the interface instructions are executable by the logic subsystem to select the selected character group responsive to a group selection operation applied to a D-pad, and where the interface instructions are executable by the logic subsystem to select the selected character responsive to a character selection operation applied to the D-pad.

17. The computing system of claim 11, where the data-holding subsystem further includes interface instructions executable by the logic subsystem to:
display a mode menu including a plurality of character entry modes, each character entry mode including a character group set; and
select, from the plurality of character entry modes, a selected character entry mode responsive to a mode selection operation applied to the directional controller.

18. The computing system of claim 11, where the data-holding subsystem further includes interface instructions executable by the logic subsystem to display the selected character in a character entry box on the display.

19. A computer-readable storage medium comprising interface instructions stored thereon that are executable by a computing system to perform a method of character selection and entry, the method including:
displaying a character group menu on a display of the computing system, the character group menu including a plurality of character groups radially arranged around a central region of the character group menu, each of the plurality of character groups being selectable and having a plurality of characters;
selecting, from the plurality of character groups of the character group menu, a selected character group in response to a group selection operation applied to a directional controller of the computing system, where the selecting of the selected character group is dependent upon a direction of the group selection operation;
replacing, on the display, the character group menu with a character menu in response to the selecting of the selected character group, the character menu including the plurality of characters of the selected character group radially arranged around a central region of the character menu; and
selecting, from the plurality of characters of the character menu, a selected character in response to a character selection operation applied to the directional controller, where the selecting of the selected character is dependent upon a direction of the character selection operation.

20. The computer-readable storage medium of claim 19, where the selecting of the selected character group occurs responsive to a group selection operation applied to a joystick and the selecting of the selected character occurs responsive to a character selection operation applied to the joystick.
